(19) United States
(12) Patent Application Publication
(10) Pub. No.: US 2006/0145809 A1
(43) Pub. Date: Jul. 6, 2006

(54) Passive entry system

(75) Inventor: Peter Edward Crowhurst, Victoria (AU)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: AUSTRALIAN NARROW PTY LTD., VICTORIA (AU)

(21) Appl. No.: 10/535,551

(22) PCT Filed: Nov. 17, 2003
(86) PCT No.: PCT/AU03/01535

§ 371 Date: Nov. 16, 2005

(30) Foreign Application Priority Data
Nov. 19, 2002 (AU) 2002952753

(51) Int. Cl. G05B 19/00

(52) U.S. Cl. 340/5.62; 340/5.61; 340/10.1; 340/10.34; 340/5.72; 340/426.36; 340/426.16

(57) ABSTRACT

A system to enable an authorized person access or entry or use of to a restricted area or location or apparatus includes a base station (14) that, on initiation, transmits one or more actuating signals, either at predetermined intervals or on the occurrence of a predefined event The signals are received by any transponder (12) that is within range. Each transponder (26, 27, 28, 29) receiving the actuation signal reacts by transmitting a unique, coded response signal (21, 22, 23, 24) that is received by a receiver associated with the base station (14). A base station processor processes the received response signals (21, 22, 23, 24) and perform a Fourier transform and/or a spectral analysis on the received signal combination to develop an identification of the individual received response signals. The base station selects one of the identified response signals and authenticates the transponder (26, 27, 28, 29) responsible for the transmission of that selected response signal.

### FIELD OF THE INVENTION

This invention relates to an entry system and in particular to a system that will allow authorised entry to or facilitate access to a restricted area using an access communications protocol without which entry or access will be denied.

While the invention will be described with particular references to passive access to a motor vehicle, it will be appreciated that the invention has broader application and may be adapted for use in relation to access or entry to any form of restricted area or space, including buildings, rooms, containers of all types, other vehicles and equipment and the like. Accordingly, the following description should be read with the understanding the invention is not limited to the particular applications described.

### BACKGROUND OF THE INVENTION

It has been proposed to provide motor vehicles with a passive access system which allows an authorised person access to the vehicle. In one such proposed system, a user initiates an access communications protocol by, for example, touching or lifting a door handle or even simply by approaching the vehicle. When the access communications protocol is initiated, a radio signal is transmitted by a base station transmitter/receiver located in the vehicle. The authorised person will carry a transponder which responds to the transmitted signal by transmitting it's own signal that contains an identification code. The transmitted identification code is received, recognised and authenticated by the base station which then initiates an actuator so that one or more vehicle doors are unlocked.

In many instances, however, more than one transponder may be in proximity to the vehicle, and each transponder may respond to the transmitted signal. Accordingly, a plurality of response signals is received by the base station which may be unable to recognise and identify the correct individual signal.

When a multiplicity of signals are transmitted substantially simultaneously, the signals can be linearly added together, which results in the correct, individual signal being sufficiently degraded as to prevent adequate decoding by the base station.

It has been proposed to use time slots for individual response signals to enable separation of individual signals. However, when a plurality of transponders are associated with a particular vehicle, such as for a business car pool or the like, long, undesirable timing delays occur which are associated with the time slots allocated to each transponder associated with the vehicle.

Still farther, transponders associated with other vehicles may also be caused to respond to an initiating base station signal. Such extraneous transponder responses may also result in the received data at the base station being composed of signals from more than one transponder, and so be corrupted.

It is therefore desirable to provide an improved system to facilitate access or entry to a restricted location.

It is also desirable to provide an improved passive access system which is able to respond to two or more transponder signals upon initiation of an access communications protocol.

It is also desirable to provide an improved passive access system which avoids delay in response time which may otherwise occur with time slot or other separation systems.

It is also desirable to provide an improved passive access system whereby any number of transponders may be programmed to be associated with one entry or access base station.

It is also desirable to provide an improved passive access or entry system, particularly for motor vehicles, which may be used in a variety of applications and with different forms of coding sequences, identifying signals and signal sequences.

### SUMMARY OF THE INVENTION

In accordance with one aspect of the invention there is provided a passive access system to enable an authorised user access or entry to a restricted location comprising:

a base station;

initiation means to initiate an access communications protocol, the protocol including the transmission by the base station of one or more actuating signals;

one or more transponder means each responsive to the actuating signal to transmit an individual coded response signal;

processor means to process the received response signals and to perform a spectral analysis thereon to develop an identification of the individual received response signals; and

the base station selecting one of the identified response signals and authenticating the transponder responsible for the transmission of that selected response signal.

The initiation means, according to one embodiment of the invention, may include an electrical switch associated with a door handle such that relative movement of the door handle initiates the access communications protocol.

In another embodiment, the initiation means includes proximity sensors in or on the vehicle that sense the presence of a person adjacent the vehicle or, more preferably, a contact by a person with the vehicle. Such sensors, known in the art, are arranged to initiate the access communications protocol.

Preferably, the actuating signal transmitted by the base station is a low frequency signal having a field range of, for example, between 0.5 and 2.5 m. When the invention is used in relation to a motor vehicle, any and all transponders which are within the low frequency field will respond to that field for a predetermined period of time with a unique tone or dual tone multiple frequency (DTMF) signal or multiple tones.

Preferably, the signals transmitted by the transponders are received and processed by an RF receiver and demodulator associated with the base station. The demodulated, composite signal is then processed by the base station signal processor which performs a spectral analysis thereon.

Preferably, the spectral analysis is Fast Fourier Transform (FFT) performed on the time domain signal.

In one embodiment, the resulting spectrum computed by the FFT will be a number of tones representative of the number of transponders present in the LF field. On detection of these tones, the base station controller may then perform a check to determine which of the transponders has the highest priority. That transponder may then be interrogated by the base station for authentication.

In another embodiment, after selecting one of the identified response signals, the base station is tuned to the unique identification signal of the selected transponder for authentication.

According to another aspect of the invention there is provided an access control system to enable an authorised person access or entry to a restricted area or location or use of restricted apparatus and comprising a base station adapted to transmit one or more actuating signals either at predetermined intervals or on the occurrence of a predefined event, one or more transponder means each responsive to the actuating signal to transmit an individual, coded response signal, processor means to process the received response signals and to perform a Fourier transform and/or spectral analysis to develop an identification of the individual received response signals, the base station selecting one of the identified response signals and authenticating the transponder responsible for the transmission of that selected response signal.

In order that the invention will be more readily understood, one embodiment thereof will now be described with reference to the accompanying drawings.

### DESCRIPTION OF THE DRAWINGS

FIG. 1 illustrates the signal transmission of a single transponder;

FIG. 2 shows the tone spectrum of the single transmission;

FIG. 3 illustrates multiple transponder signals;

FIG. 4 shows the linearly added signals received by the base station; and

FIG. 5 shows the spectrum separation achieved by this embodiment of the invention.

### DESCRIPTION OF THE PREFERRED EMBODIMENTS

Many motor vehicles have a plurality of keys, incorporating transponders, assigned to the vehicle. Generally, the keys are allocated individual serial numbers that separate them from other keys assigned to the same vehicle but which also links them to the given vehicle. Therefore, each key has a unique number both for itself and in relation to the assigned vehicle.

When keys are tied to a given vehicle the transponders are assigned a tone or DTMF code or multiple codes that will link them to a particular serial number that is unique to them and which is known to the base station located in the vehicle. When any of the transponders assigned to a vehicle, or even transponders assigned to other vehicles, are within an LF field initiated by a base station, on actuation of a door handle switch or the like, all the transponders will respond for a given period of time by generating signals with unique tones or DTMF signals or multiple tones.

For all signals transmitted to air, the atmosphere either in free space or in a vacuum represents an environment where signals can be linearly added together. In the case where there is more than one transponder in the LF field established by the base station, then the transmitted RF signals from each transponder are linearly added.

Normally, this would result in a signal received by the base station receiver being sufficiently degraded to not allow adequate decoding.

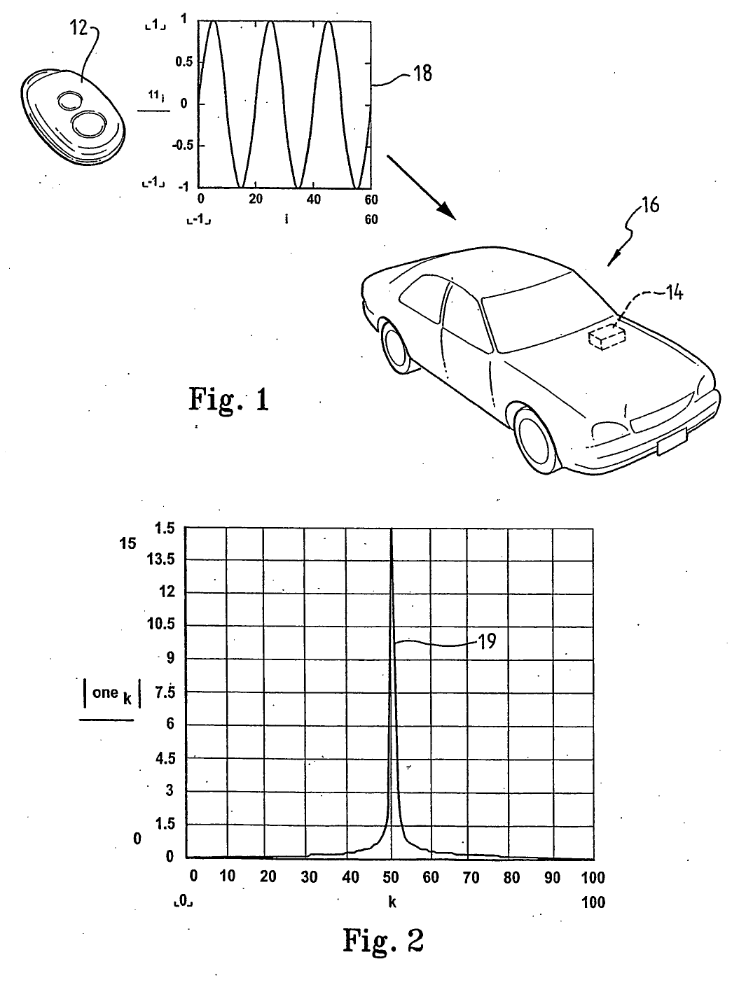

Referring to the drawings, FIGS. 1 and 2 illustrates the manner of operation of a passive access system where only a single key/transponder is associated with the vehicle. The drawing illustrates a vehicle 16 and an associated key that incorporates a transponder 12. The vehicle contains a base station 14 that, on actuation, transmits a low frequency (LF) radio signal over a restricted range of between 0.5 and 3.0 metres. The actuation may be initiated by contact with the vehicle, lifting of a door handle or even actuation of a press-button on the transponder 12.

When the single key and transponder 12 is present within the LF field initiated by a base station 14, the transponder transmits a response signal 18 that is received by an RF receiver associated with the base station 14. In the drawings, only the base band signal 18 has been represented. However, that base signal will contain coded information representing the key serial number and the associated vehicle. The transmitted data from the key is seen in FIG. 2 as a single spectral component 19 by the vehicle signal processing controller of the base station 14.

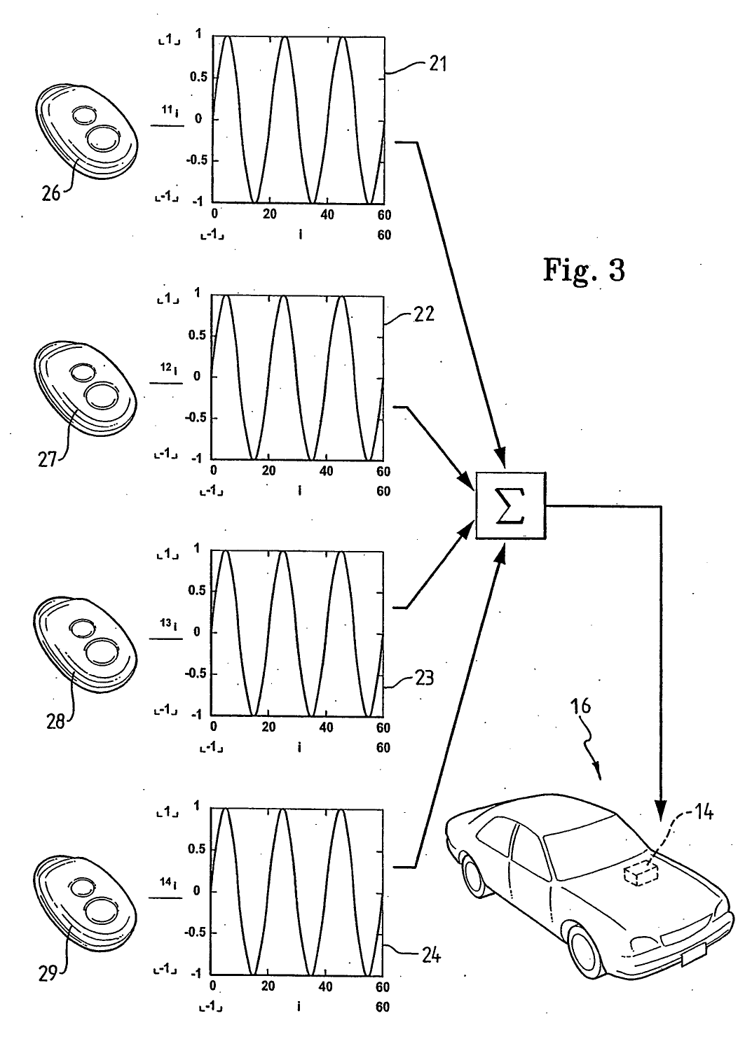

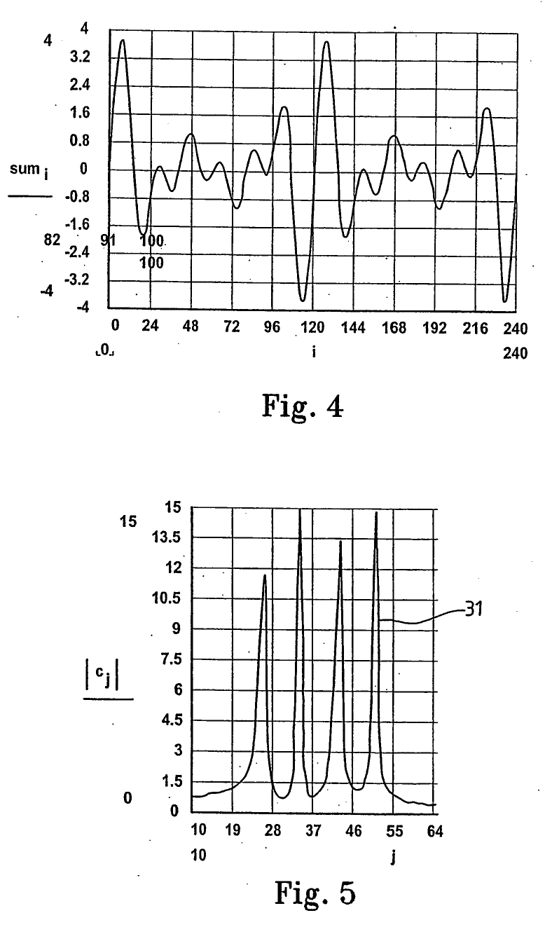

On this basis, the time domain signal 18 transmitted by the transponder is that received by the base station 14. In this instance, with a single signal transmission, there is no degradation experienced in the signal received at the base station, and the base station is able to decode the coded information and, if necessary, interrogate the transponder for further, authenticating data Referring to FIG. 3, in the situation where more than one key/transponder is present in the LF field, the individual response signals 21, 22, 23 and 24 transmitted by the four key/transponders 26, 27, 28 and 29, respectively are linearly added together when received by the RF receiver of the base station 14. The individual transmitted signals 21-24, as shown in FIG. 3, are all distinct signals having their own individual identity. When summed together the resulting received signal is a composite of the transmitted signals as shown in FIG. 4. Ordinarily, the received signal of FIG. 4 could not be decoded and, hence, with all the transponder signals 21 to 24 colliding with each other, the base station is prevented from recognising and authenticating any one of the four transponders.

However, in accordance with this embodiment of the invention, the signal processor of the base station 14 performs a Fast Fourier Transform (FFT to the received signal shown in FIG. 4. The result of the FFT is the transformed signal 31 shown in FIG. 5 and which separates the four spectral components into the four separate signals to allow further signal processing to be performed on the received signal. By this means, the identity of the individual transponders 26 to 29 may be ascertained. The base station 14 is then able to select one of those transponders to establish authentication and provide access to the vehicle. In this embodiment of the authentication process, a unique code to which only the selected transponder will respond is transmitted by the base station and the coded response is used for access authorisation.

When transponders are initially associated with, assigned to or programmed to a vehicle each of them is assigned a unique identity number, which may be associated with a vehicle manufacturer, a key number and a unique tone for the individual vehicle. Each vehicle may have a number of keys/transponders, all the identities of which will be pre-programmed into the vehicle base station, and all of which will be distinct. Thus, key number one for a particular vehicle may have tone number one, key number two has tone two, and so on. On initiation of the passive entry or passive access system, by actuation of a door handle switch, boot lid switch or other known form of passive actuation initiation, the base station will transmit a command via the LF field to which all the transponders will respond if they are within range of the LF field. The base station 14, on receipt of the identifying transponder tones, and after performing a spectral analysis, such as FFT, on the received signal to separate the individual tones of each transponder, will select one of the transponders using the key number identifier, and only this key/transponder will respond to the authentication process commands transmitted by the base station. The selection process for a particular key to respond may be arbitrary, or may be coded to key/transponders in a predetermined hierarchal order.

It will be appreciated that the system of the invention is able to be used to separate received signals transmitted by transponders unassociated with the vehicle in question. Thus, if a transponder from another vehicle is within range and is actuated by the initiating signal, the invention will be able to distinguish any such transmitted signal from others received by the base station receiver.

Although the invention has been described using a Fourier transfer and/or spectral analysis, it will be understood that other forms of numerical analysis may be used in the performance of the invention.

Many modifications may be made in the design, construction and operation of a passive access system in accordance with the present invention. Such modifications may include adapting the system for use in providing access or entry to a building, container or other restricted area or location.

Still further, the system of the invention may also be used in relation to other forms of access or entry control systems which involve the initiation of or continuous transmission of a transponder awakening signal. Thus, the system of the invention may be adapted for use with a vehicle, building or other restricted area control system wherein a continuous transponder initiation signal is transmitted, at low frequency and low range, without the necessity to have a user actuate an initiation switch or the like.

1. A passive access system to enable an authorised user access or entry to a restricted location, area, vehicle, machine or equipment, comprising:
a base station;
initiation means to initiate an access communications protocol, the protocol including the transmission by the base station of one or more actuating signals;
one or more transponder means each responsive to the actuating signal to transmit an individual coded response signal;
processor means to process the received response signals and to perform a Fourier or other spectral analysis thereon to develop an identification of the individual received response signals; and
the base station selecting one of the identified response signals and authenticating the transponder responsible for the transmission of that selected response signal.

2. A passive access system according to claim 1 wherein the initiation means includes an electrical switch associated with a door handle such that relative movement of the door handle initiates the access communications protocol.

3. A passive access system according to claim 1 wherein the initiation means includes proximity sensors in or on a vehicle, the proximity sensor sensing the presence of a person adjacent the vehicle.

4. A passive access system according to claim 1 wherein the initiation means includes proximity sensors in or on a vehicle that senses a person contacting the vehicle.

5. A passive access system according to claim 1 wherein the actuating signal transmitted by the base station is a low frequency (LF) signal having a field range of between 0.5 and 3 metres.

6. A passive access system according to claim 1 wherein the individual coded response signal transmitted by each transponder that receives the base station transmitted actuation signal is a unique tone or dual tone multiple frequency (DTMF) signal or multiple tones, the response signal including an identification code unique to each transponder.

7. A passive access system according to claim 1 wherein the response signal transmitted by each transponder is received and processed by an RF receiver and demodulator associated with the base station.

8. A passive access system according to claim 7 wherein the demodulated, composite signal is then processed by the base station signal processor which performs a spectral analysis thereon.

9. A passive access system according to claim 8 wherein the spectral analysis is a Fast Fourier Transform (FFT) performed on the time domain signal.

10. A passive access system according to claim 9 wherein the resulting spectrum computed by the FFT will be a number of tones representative of the number of transponders present in the LF field.

11. A passive access system according to claim 10 wherein on detection of the tones, the base station controller then performs a check to determine which of the transponders has the highest preset priority.

12. A passive access system according to claim 11 wherein the transponder with the highest preset priority is interrogated by the base station for authentication.

13. A passive access system according to claim 1 wherein after selecting one of the identified response signals, the base station is tuned to the unique identification signal of the selected transponder for authentication.

14. A passive access system according to claim 1 wherein, in the authentication process, a unique authentication code to which only the selected transponder will respond is transmitted by the base station and the coded response is used for access authorisation.

15. A passive access system according to claim 1 wherein said authorised user access or entry is to a motor vehicle, and each transponder is associated with, assigned to or programmed to particular vehicle, and each transponder is assigned a unique identity number, which is associated with a vehicle manufacturer, a key number and a unique tone for the individual vehicle.

16. A passive access system according to claim 14 wherein each vehicle has a number of associated transponders, the identities of all of which are pre-programmed into the respective vehicle base station, and all of which are unique whereby each transponder associated with each vehicle is uniquely identified.

17. An access control system to enable an authorised user to gain access or entry to a restricted area, location, vehicle, machine or equipment, and comprising a base station adapted to transmit one or more actuating signals either at predetermined intervals or on the occurrence of a predefined event, one or more transponder means each responsive to the actuating signal to transmit an individual, coded response signal, processor means to process the received response signals and to perform a Fourier transform and/or spectral analysis on the response signal to develop an identification of separate, individual received response signals, the base station selecting one of the identified response signals and authenticating the transponder responsible for the transmission of that selected response signal.

18. A passive access system according to claim 17 wherein said predefined event comprises actuation of an electrical switch associated with a door handle such that relative movement of the door handle initiates the transmission of the actuating signal.

19. A passive access system according to claim 17 wherein said predefined event comprises actuation of proximity sensors in or on a vehicle, the proximity sensor sensing the presence of a person adjacent the vehicle and initiating the transmission of the actuating signal.

20. A passive access system according to claim 17 wherein said predefined event comprises actuation of proximity sensors in or on a vehicle, the proximity sensor sensing a person contacting the vehicle and initiating the transmission of the actuating signal.

21. A passive access system according to claim 1 wherein the actuating signal transmitted by the base station is a low frequency (LF) signal having a field range of between 0.5 and 3 metres.

22. A passive access system according to claim 17 wherein the individual coded response signal transmitted by each transponder that receives the base station transmitted actuation signal is a unique tone or dual tone multiple frequency (DTMF) signal or multiple tones, the response signal including an identification code unique to each transponder.

23. A passive access system according to claim 1 wherein the response signal transmitted by each transponder is received and processed by an RF receiver and demodulator associated with the base station.

24. A passive access system according to claim 23 wherein the demodulated, composite signal is then processed by the base station signal processor which performs a spectral analysis thereon.

25. A passive access system according to claim 24 wherein the spectral analysis is a Fast Fourier Transform (FFT) performed on the time domain signal.

26. A passive access system according to claim 25 wherein the resulting spectrum computed by the FFT will be a number of tones representative of the number of transponders present in the LF field.

27. A passive access system according to claim 26 wherein on detection of the tones, the base station controller then performs a check to determine which of the transponders has the highest preset priority.

28. A passive access system according to claim 27 wherein the transponder with the highest preset priority is interrogated by the base station for authentication.

29. A passive access system according to claim 17 wherein after selecting one of the identified response signals, the base station is tuned to the unique identification signal of the selected transponder for authentication.

30. A passive access system according to claim 17 wherein, in the authentication process, a unique authentication code to which only the selected transponder will respond is transmitted by the base station and the coded response is used for access authorisation.

31. A passive access system according to claim 17 wherein said authorised user access or entry is to a motor vehicle, and each transponder is associated with, assigned to or programmed to particular vehicle, and each transponder is assigned a unique identity number, which is associated with a vehicle manufacturer, a key number and a unique tone for the individual vehicle.

32. A passive access system according to claim 31 wherein each vehicle has a number of associated transponders, the identities of all of which are pre-programmed into the respective vehicle base station, and all of which are unique whereby each transponder associated with each vehicle is uniquely identified.

33. A passive access system according to claim 17 wherein said actuating signal is transmitted at predetermined intervals.

34. A passive access system according to claim 17 wherein the analysis carried out on the received response signals separates the individual spectral components of the signals into separate, identifiable signals representative of individual transponder response signals.

35. (canceled)
